(19) United States
(12) Patent Application Publication
(10) Pub. No.: US 2015/0073601 A1
(43) Pub. Date: Mar. 12, 2015

(54) TEST SYSTEM HAVING A COMPLIANT ACTUATOR ASSEMBLY AND ITERATIVELY OBTAINED DRIVE

(71) Applicant: MTS Systems Corporation, Eden Prairie, MN (US)

(72) Inventors: Peter D. Gunness, Waconia, MN (US); Glen C. Grenier, Ray, MI (US); Steven R. Haeg, Shorewood, MN (US); Kyle Joseph Dahlheimer, Center City, MN (US)

(21) Appl. No.: 14/481,659

(22) Filed: Sep. 9, 2014

Related U.S. Application Data
(60) Provisional application No. 61/875,645, filed on Sep. 9, 2013.

(51) Int. Cl. G05B 17/02

(52) U.S. Cl. CPC G05B 17/02
USPC 700/275

(57) ABSTRACT

A test system and a method includes applying a test drive signal to a physical test rig having a compliant actuator assembly for imparting loads to a test specimen. An actual response signal of the physical test rig and the test specimen to the test drive signal is obtained and an error as a function of the actual response signal and a selected response signal is calculated. If the error has not reached a selected threshold a new drive signal based on the error and a relaxation gain factor is obtained. The new drive signal is obtained and applied until the error reaches the selected threshold.

### CROSS-REFERENCE TO RELATED APPLICATIONS

This application claims the benefit of U.S. Provisional Patent Application Ser. No. 61/875,645 filed Sep. 9, 2013.

### BACKGROUND OF THE INVENTION

The present invention relates to a control of a system, machine or process. More particularly, the present invention relates to calculating a model to be used for generating drive signals as input to a vibration or other controlled system.

Vibration systems that are capable of simulating loads and/or motions applied to test specimens are generally known. Vibration systems are widely used for performance evaluation, durability tests, and various other purposes as they are highly effective in the development of products. For instance, it is quite common in the development of automobiles, motorcycles, or the like, to subject the vehicle or a substructure thereof to a laboratory environment that simulates operating conditions such as a road or test track. Physical simulation in the laboratory involves a well-known method of data acquisition and analysis in order to develop drive signals that can be applied to the vibration system to reproduce the operating environment. This method includes instrumenting the vehicle with transducers “remote” to the physical inputs of the operating environment. Common remote transducers include, but are not limited to, strain gauges, accelerometers, and displacement sensors, which implicitly define the operating environment of interest. The vehicle is then driven in the same operating environment, while remote transducer responses (internal loads and/or motions) are recorded. During simulation with the vehicle mounted to the vibration system, actuators of the vibration system are driven so as to reproduce the recorded remote transducer responses on the vehicle in the laboratory.

However, before simulated testing can occur, the relationship between the input drive signals to the vibration system and the responses of the remote transducers must be characterized in the laboratory. Typically, this “system identification” procedure involves obtaining a respective model or transfer function of the complete physical system (e.g. vibration system, test specimen, and remote transducers) hereinafter referred to as the “physical system”; calculating an inverse model or transfer function of the same; and using the inverse model or transfer function to iteratively obtain suitable drive signals for the vibration system to obtain substantially the same response from the remote transducers on the test specimen in the laboratory situation as was found in the operating environment.

As those skilled in the art would appreciate, this process of obtaining suitable drive signals is not altered when the remote transducers are not physically remote from the test system inputs (e.g. the case where “remote” transducers are the feedback variables, such as force or motion, of the vibration system controller).

Although the above-described system and method for obtaining drive signals for a vibration system has enjoyed substantial success, there is a continuing need to improve such systems. In particular, there is a need to improve models of the physical system and the process for obtaining the drive signals.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

A first aspect of the present invention is a test that includes a physical test rig having a compliant actuator assembly responsive to a drive signal and a test specimen operably connected to the compliant actuator assembly. A non-transitory computer storage device is provided and is configured to operate with a processor to execute instructions stored thereon so as to apply a test drive signal to the physical test rig. An actual response signal of the physical test rig and the test specimen to the test drive signal is obtained and an error as a function of the actual response signal and a selected response signal is calculated. If the error has not reached a selected threshold a new drive signal based on the error and a relaxation gain factor is obtained. The new drive signal is obtained and applied until the error reaches the selected threshold.

A second aspect is a method for operating a test system that includes applying a test drive signal to a physical test rig having a compliant actuator assembly for imparting loads to a test specimen. An actual response signal of the physical test rig and the test specimen to the test drive signal is obtained and an error as a function of the actual response signal and a selected response signal is calculated. If the error has not reached a selected threshold a new drive signal based on the error and a relaxation gain factor is obtained. The new drive signal is obtained and applied until the error reaches the selected threshold.

One or more of the following features can be provided in further embodiments of the aspects described above.

The relaxation gain factor is greater than 0.5, and preferably is greater than 0.65, and more preferably is greater than 0.75, and yet even more preferably is greater than 0.8. By being able to use a relaxation gain factor than that previously used before, the overall number of iterations necessary to obtain the drive using an iterative process such as those discussed below has been significantly reduced when compared to a test system not having such compliant actuator assemblies.

The method and test system are not limited by the type of model used. For example and without limitation, a linear or non-linear model can be configured for use with the physical rig and the test specimen, and wherein the new drive signal is obtained based on the error, the linear or nonlinear model and the relaxation gain factor.

The compliant actuator assembly can comprise one or more actuators each having a spring connecting the actuator to the test specimen to provide compliance; and/or include an accumulator. The accumulator can be fluidly or mechanically coupled to each of the chambers or piston of a double-acting actuator. The accumulator(s) introduce a spring effect to an otherwise substantially rigid actuator. Each accumulator can include a first portion of compressible fluid (typically, a gas such as nitrogen, mechanical spring, or other resilient media or device,) and a second portion that is filled with a liquid, which compared to the gas, is substantially incompressible. The second portion of each accumulator 164 is fluidly coupled to a bore or mechanically coupled to the piston. Commonly, a diaphragm (or equivalent separating device such as a piston) is provided in each accumulator to maintain separation of the spring device or media and the liquid. Using hydraulic accumulators, typically but not exclusively pre-charged with nitrogen gas or mechanical elements, allows tuning of the spring stiffness (i.e. the compliance) of the actuator assembly to match requirements of a specific test specimen.

The compliance of the compliant actuator assembly can be adjustable, and/or, if desired, the compliant actuator assembly is more compliant than the test specimen in one or more degrees of freedom.

Other design considerations of the actuator assembly can also be used to obtain desired performance. For instance, any or all of the area ratios between the accumulator effective area and the area of the piston, the mass of the accumulator piston and/or the velocity of oil entering/exiting the accumulator can be used to tune the compliance to be effective at low frequencies yet become substantially inert or at least substantially stiffer at higher frequencies that warrant less compliance and more stiffness.

A particular advantage of the method and test system described above in any of the foregoing embodiments is that the test specimen in the test system can be replaced with a new test specimen being similar but different than the test specimen. The drive signal that corresponds to the error reaching the selected threshold is applied to conduct testing on the new test specimen. In prior art systems, a new drive signal would need to be generated, which takes a considerable amount of time. Instead, because of the compliant actuator assembly the same drive signal can be used on similar but different test specimens.

As used herein, “similar but different test specimens” are test specimens having the overall same structure for use in the test specimen, but each similar but different test specimen is different in at least one respect such as but not limited to different structure, element, material, operating parameter characteristic, value, setting or adjustment. Stated in another way, two test specimens are similar but different if test results obtained from each test specimen are suitable when the same drive signal is used to test each of the test specimens. If the same afore-mentioned test specimens are used in the test system that is otherwise substantially the same but does not include one or more compliant actuator assemblies and the test results obtained would not be suitable if the same drive signal is applied to each test specimen, then the two test specimens are similar but different.

The method and test system are particularly advantageous for a test specimen that is at least a portion of a vehicle, wherein at least one of the compliant actuator assembly is configured to apply a load upon said at least a portion of the vehicle, particularly in a direction corresponding substantially to forward motion or motion being lateral to forward motion of the vehicle.

### BRIEF DESCRIPTION OF THE DRAWINGS

FIG. 1 is a schematic block diagram of a prior art test system.

FIG. 2 is a schematic diagram of a suitable computing environment.

FIG. 3A is a flow chart illustrating the steps involved in an identification phase of a prior art method of vibration testing.

FIG. 3B is a flow chart illustrating the steps involved in an iterative phase of a prior art method of vibration testing.

FIG. 3C is a flow chart illustrating the steps involved in another iterative phase of a prior art method of vibration testing.

FIG. 4A is a detailed block diagram of a prior art iterative process for obtaining drive signals for a vibration system with an adjuster.

FIG. 4B is a detailed block diagram of another prior art iterative process for obtaining drive signals for a vibration system with the adjuster of the present invention.

FIG. 5 is a schematic block diagram of a test system having an aspect of the invention.

FIG. 6 is a schematic diagram of a compliant actuator assembly.

FIG. 7 is a schematic block diagram of a physical test rig having an aspect of the invention.

FIG. 8 is a schematic block diagram illustrating an identification phase of a prior art method of vibration testing.

FIG. 9 is a schematic block diagram illustrating an iterative phase of a prior art method of vibration testing.

### DETAILED DESCRIPTION OF THE ILLUSTRATIVE EMBODIMENTS

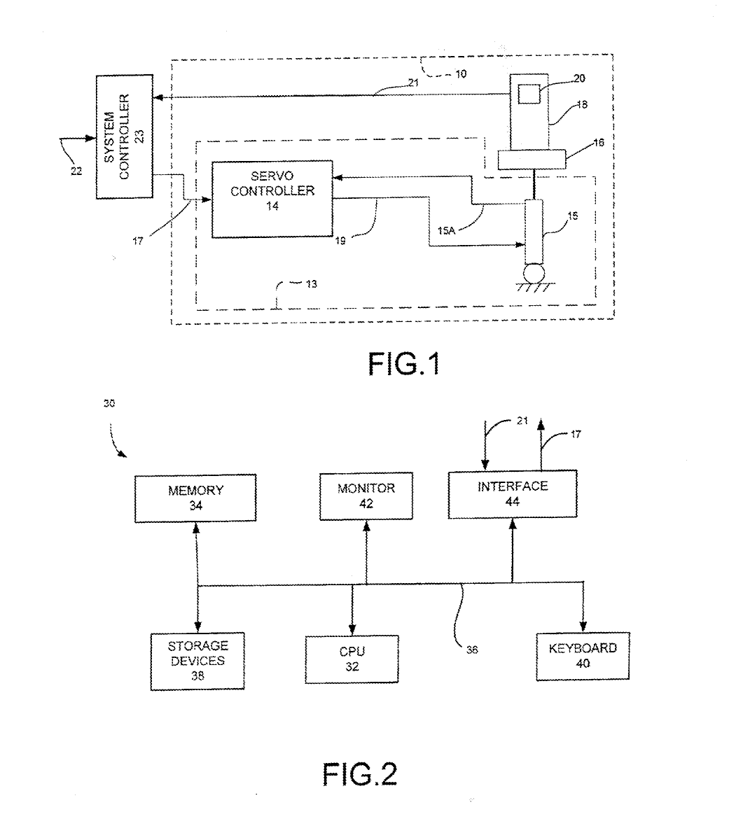

FIG. 1 illustrates a physical system 10. The physical system 10 generally includes a vibration system 13 comprising a servo controller 14 and an actuator 15. In the schematic illustration of FIG. 1, the actuator 15 represents one or more actuators that are coupled through a suitable mechanical interface 16 to a test specimen 18. The servo controller 14 provides an actuator command signal 19 to the actuator 15, which in turn, excites the test specimen 18. Suitable feedback 15A is provided from the actuator 15 to the servo controller 14. One or more remote transducers 20 on the test specimen 18, such as displacement sensors, strain gauges, accelerometers, or the like, provide a measured or actual response 21. A physical system controller 23 receives the actual response 21 as feedback to compute a drive 17 as input to the physical system 10. In one embodiment of an exemplary iterative process discussed below, the physical system controller 23 generates the drive 17 for the physical system 10 based on the comparison of a desired response provided at 22 and the actual response 21 of the remote transducer 20 on the test specimen 18. Although illustrated in FIG. 1 for the single channel case, multiple channel embodiments with response 21 comprising N response components and the drive 17 comprising M drive components are typical and considered another embodiment of the present invention.

FIG. 2 and the related discussion provide a brief, general description of a suitable computing environment in which the invention may be implemented. Although not required, the physical system controller 23 will be described, at least in part, in the general context of computer-executable instructions, such as program modules, being executed by a computer 30. Generally, program modules include routine programs, objects, components, data structures, etc., which perform particular tasks or implement particular abstract data types. The program modules are illustrated below using block diagrams and flowcharts. Those skilled in the art can implement the block diagrams and flowcharts to computer-executable instructions. Moreover, those skilled in the art will appreciate that the invention may be practiced with other computer system configurations, including multi-processor systems, networked personal computers, mini computers, main frame computers, and the like. The invention may also be practiced in distributed computing environments where tasks are performed by remote processing devices that are linked through a communications network. In a distributed computer environment, program modules may be located in both local and remote memory storage devices.

The computer 30 illustrated in FIG. 2 comprises a conventional personal or desktop computer having a central processing unit (CPU) 32, memory 34 and a system bus 36, which couples various system components, including the memory 34 to the CPU 32. The system bus 36 may be any of several types of bus structures including a memory bus or a memory controller, a peripheral bus, and a local bus using any of a variety of bus architectures. The memory 34 includes read only memory (ROM) and random access memory (RAM). A basic input/output (BIOS) containing the basic routine that helps to transfer information between elements within the computer 30, such as during start-up, is stored in ROM. Non-transitory computer readable storage devices 38, such as a hard disk, an optical disk drive, ROM, RAM, flash memory cards, digital video disks etc., are coupled to the system bus 36 and are used for storage of programs and data. Commonly, programs are loaded into memory 34 from at least one of the storage devices 38 with or without accompanying data.

An input device 40 such as a keyboard, pointing device (mouse), or the like, allows the user to provide commands to the computer 30. A monitor 42 or other type of output device is further connected to the system bus 36 via a suitable interface and provides feedback to the user. The desired response 22 can be provided as an input to the computer 30 through a communications link, such as a modem, or through the removable media of the storage devices 38. The drive signals 17 are provided to the physical system 10 of FIG. 1 based on program modules executed by the computer 30 and through a suitable interface 44 coupling the computer 30 to the vibration system 13. The interface 44 also receives the actual response 21.

Before describing the present invention, it may also be helpful to review, in detail, an exemplary known method for modeling the physical system 10 and obtaining the drive 17 to be applied thereto. Although described below with respect to a test vehicle, it should be understood that this prior art method and the present invention discussed below are not confined to testing only vehicles, but can be used on other processes, types of test specimens and substructures or components thereof. In addition, the description is done assuming spectral analysis based modeling estimation and implementation though operations can be carried by several other mathematical techniques (e.g. Adaptive Inverse Control (AIC) type models, parametric regression techniques such as Auto Regressive Exogenous (ARX) and State Space types of models, or combinations thereof).

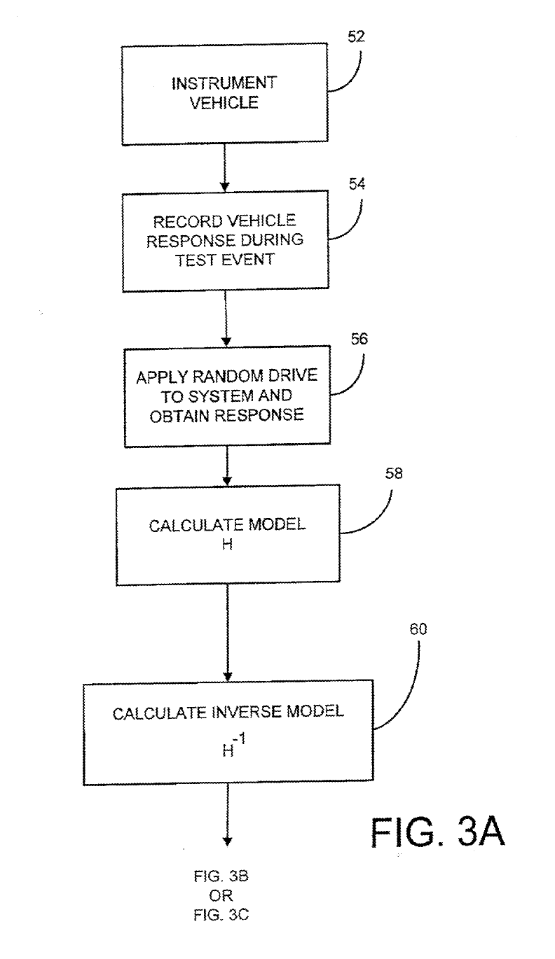

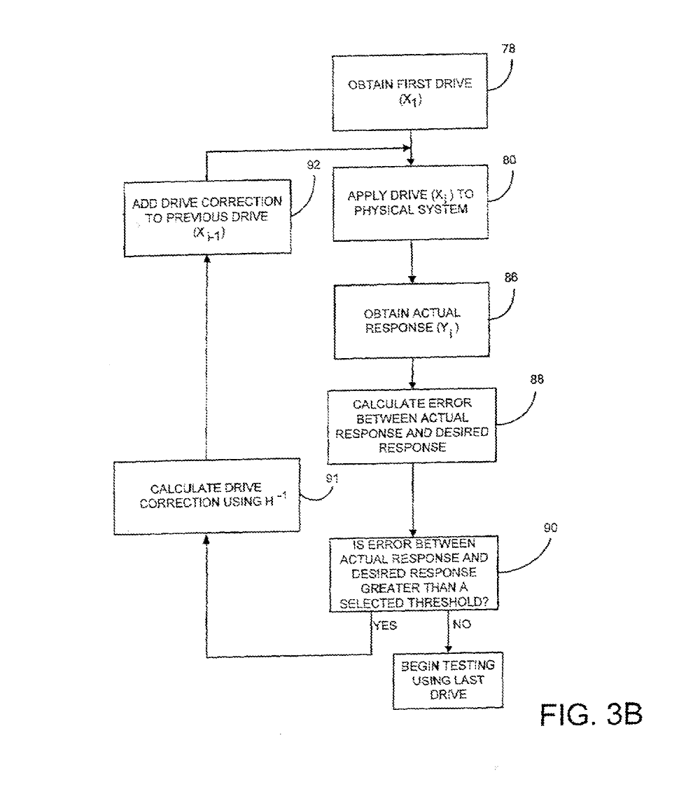

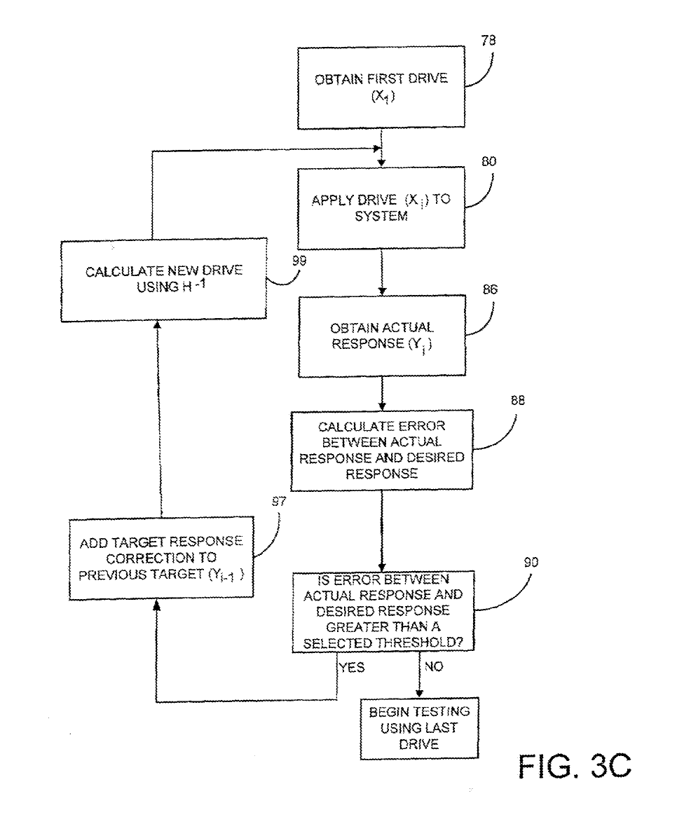

Referring to FIG. 3A, at step 52, the test vehicle is instrumented with the remote transducers 20. At step 54, the vehicle is subjected to the field operating environment of interest and the remote transducer responses are measured and recorded. For instance, the vehicle can be driven on a road or test track. The measured remote transducer responses, typically analog, are stored in the computer 30 in a digital format through analog-to-digital converters, as is commonly known.

Next, in an identification phase, the input/output model of the physical system 10 is determined. This procedure includes providing drive 17 as an input to the physical system 10 and measuring the remote transducer response 21 as an output at step 56. The drive 17 used for model estimation can be random “white noise” having frequency components over a selected bandwidth. At step 58, an estimate of the model of the physical system 10 is calculated based on the input drive applied and the remote transducer response obtained at step 56. In one embodiment, this is commonly known as the “frequency response function” (FRF). Mathematically, the FRF is a N×M matrix wherein each element is a frequency dependent complex variable (gain and phase versus frequency). The columns of the matrix correspond to the inputs, while the rows correspond to the outputs. As appreciated by those skilled in the art, the FRF may also be obtained directly from prior tests using the physical system 10 or other systems substantially similar to the physical system 10.

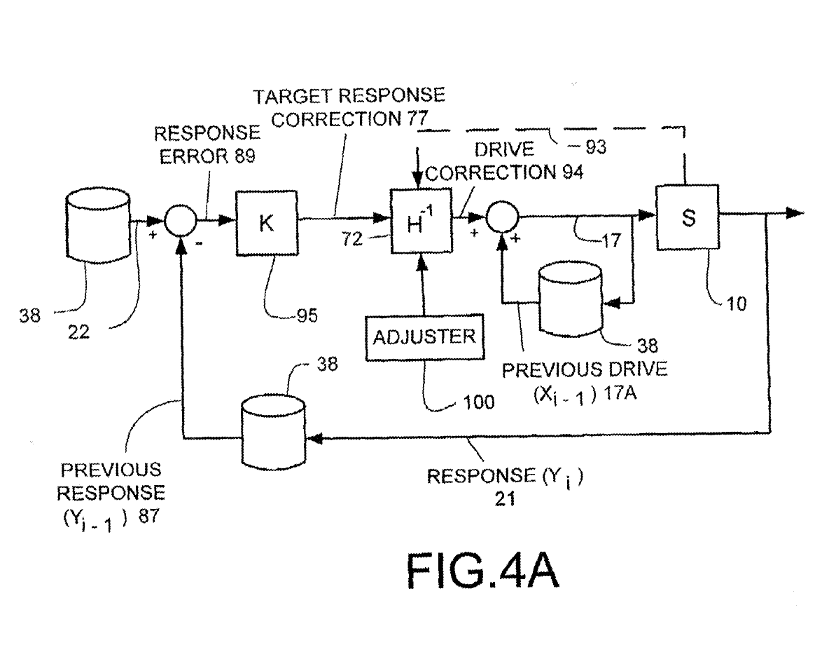

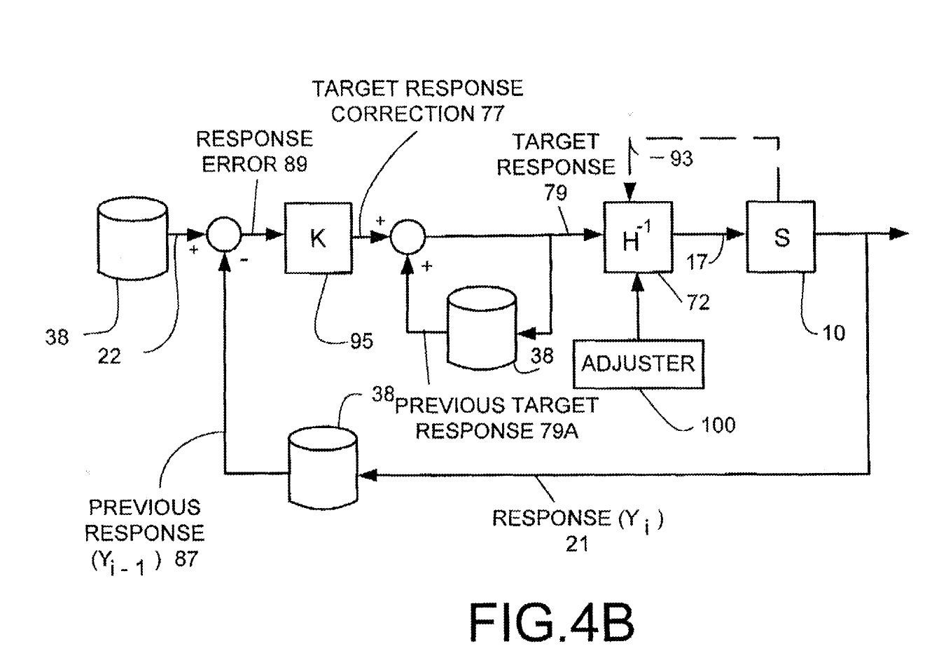

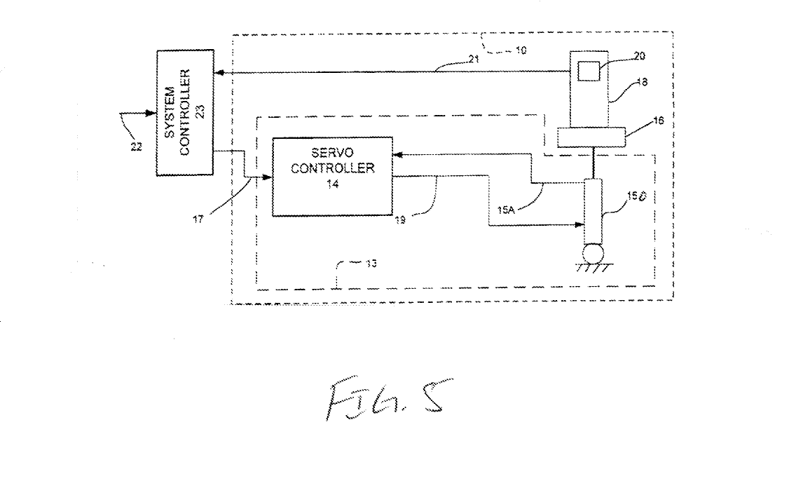

An inverse model H(f)⁻¹ is needed to determine the physical drive 17 as a function of the remote responses at step 60. As appreciated by those skilled in the art, the inverse model can be calculated directly. Also, the term “inverse” model as used herein includes a M×N “pseudo-inverse” model for a non-square N×M system. Furthermore, different forward models H and the inverse models H(f)⁻¹ can be used such as regions with “brakes on” and “brakes off” in a spindle coupled vehicle test system. At this point in the prior art, the method enters an iterative phase, illustrated in FIGS. 3B and 4A, to obtain drive 17 which produces actual response 21 that ideally replicates the desired remote transducer response 22 (hereinafter “desired response”). The inverse physical system model H(f)⁻¹ is represented at 72, while physical system (vibration system, test vehicle, remote transducers and instrumentation) is represented at 10. Referring to FIG. 3B, at step 78, the inverse model 72 is applied to a target response correction 77 in order to determine an initial drive 17 x₁(t). The target response correction 77 can be the desired response 22 for the initial drive, though most often it is reduced by a relaxation gain factor 95. The calculated drive 17 x₁(t) from the inverse model 72 is then applied to the physical system 10 at step 80. The actual remote transducer response 21 (hereinafter “actual response”) y₁(t) of the physical system 10 to the applied drive 17 x₁(t) is then obtained at step 86. If the complete physical system 10 is linear (allowing a relaxation gain 95 of unity), then the initial drive 17 x₁(t) could be used as the required drive. However, since physical systems are typically non-linear, the correct drive 17 has to be arrived at by an iterative process. (As appreciated by those skilled in the art, drive 17 used in previous tests for a similar physical system may be used as the initial drive.)

The iterative process involves recording the first actual response y₁(t) resulting from the initial drive x₁(t) and comparing it with the desired response 22 and calculating a response error 89 Δy₁ as the difference at step 88. (The first actual response signal y₁(t) is provided at 87 in FIG. 4A.) The response error 89 Δy₁ is compared to a preselected threshold at step 90 and if the response error 89 exceeds the threshold an iteration is performed. Specifically the response error 89 Δy₁ is reduced by the relaxation gain factor 95 to provide the new target response correction 77. In this embodiment, the inverse transfer function H(f)⁻¹ is applied to the new target response correction 77 to create a drive correction Δx₂ 94 (step 91) that is added to the first drive x₁(t) 17A to give a second drive x₂(t) 17 at step 92. The iteration process (steps 80-92) is repeated until the response error 89 is brought down below the preselected threshold on all channels of the response. The last drive 17, which produced a response 21, that was within the predetermined threshold of the desired response 22, can then be used to perform specimen testing.

As described, the response error 89 Δy is commonly reduced by the relaxation gain factor (or iteration gain) 95 to form the target response correction 77. The iteration gain 95 stabilizes the iterative process and trades off rate-of-convergence against iteration overshoot. Furthermore, the iteration gain 95 minimizes the possibility that the test vehicle will be overloaded during the iteration process due to non-linearities present in the physical system 10. As appreciated by those skilled in the art, an iteration gain can be applied to the drive correction 94 Δx and/or the response error 89. It should be noted in FIG. 4A that storage devices 38 can be used to store the desired response 22, the actual responses 21 and previous drives 17A during the iterative process. Of course, memory 34 can also be used. Also, a dashed line 93 indicates that the inverse model 72 is an estimate of the inverse of the physical system 10. The block diagram of FIG. 4A, as discussed above, can be implemented by those skilled in the art using commercially available software modules such as included with RPCIII™ from MTS Systems Corporation of Eden Prairie, Minn.

At this point, a modified method of the prior art for calculating the drive can also be discussed. The modified prior art method includes the steps of the identification phase illustrated in FIG. 3A and many of the steps of the iterative phase illustrated in FIG. 3B. For convenience, the iterative steps of the modified method are illustrated in FIG. 3C and the block diagram as illustrated in FIG. 4B. As illustrated in FIG. 4B, the calculation of the target response correction 77 is identical. However, if the response error 89 between the actual response 21 and the desired response 22 is greater than a selected threshold, then the target response correction 77 is added to a previous target response 79A at step 97 to obtain a new target response 79 for the current iteration. The inverse model 72 is applied to the target response 79 to obtain the new drive 17. As illustrated in FIG. 4B, the iteration gain 95 can be used for the reasons discussed above.

FIGS. 4A and 4B generally illustrate another type of iterative process that includes an adjuster 100 that operates during each step of the iterative process, to improve the physical system inverse model 72. This process is described in detail in U.S. Pat. No. 7,031,949, which is hereby incorporated by reference in it's entirety. Generally, as illustrated in FIG. 4A, the adjuster 100 corrects the inverse model 72 which receives the target response correction 77 directly as a simple function of the response error 89 (i.e. without previous target information 79A of FIG. 4B) and where the physical system drive 17 comprises drive correction 94 in combination with a previous drive 17A. Conversely, as illustrated in FIG. 4B, the inverse model 72 receives the target response 79 as the combination of the target response correction 77 and the previous target response 79A, and drive 17 is directly obtained by applying the inverse model 72. In the case of FIG. 4B, the adjuster 100 corrects the inverse model 72 in a conceptually identical fashion as in FIG. 4A. However, the configurations of FIGS. 4A and 4B render different signals available to the virtual identity modeling process described in U.S. Pat. No. 7,031,949, each with inherent situational advantages. The adjuster 100 can also operate in an iterative manner.

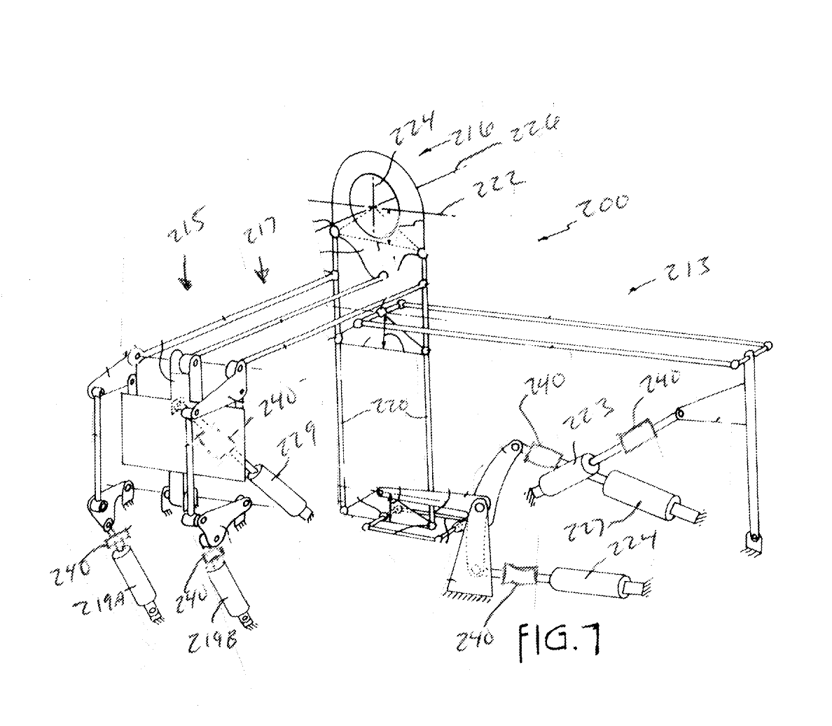

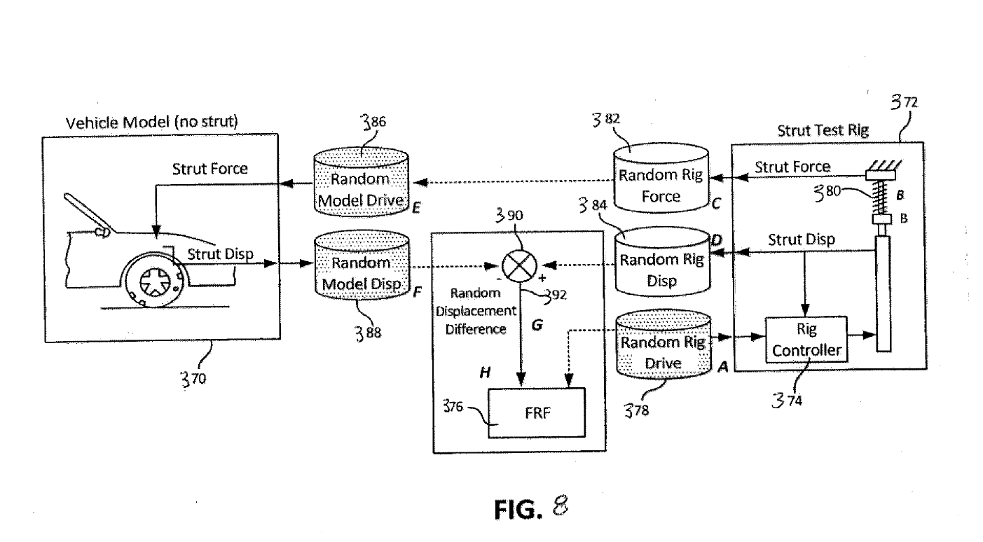

Generally, an aspect of the invention is schematically illustrated in FIG. 5, which is similar to FIG. 1; however, actuator 15 has been replaced with a compliant actuator assembly 150. When embodied in a test rig to generate loads upon the test specimen simulating actual loads seen by the test specimen, the compliant actuator assembly 150 must be able to generate high loads at high frequencies commonly seen in such systems. However, the compliant actuator assembly 150 exhibits a low stiffness spring characteristic such that displacement of the test specimen 18 can be accommodated. In the schematic diagram of FIG. 5, such characteristics may not be appreciated; however when applied in a test system for applying loads in multiple degrees of freedom such as a road simulator having one or more vehicle spindles each with a vehicle spindle test fixture 200 illustrated in FIG. 7 that applies loads to the vehicle spindle to simulate the vehicle traveling along a course, such compliance in one or more degrees of freedom, and in particular for horizontal loads (those in the direction of simulated forward motion of the vehicle and lateral thereto and also camber and steer moments), has been found to be very advantageous. Providing compliant actuator assemblies in the load path for one or more horizontal loads when testing a vehicle may allow the tester to test vehicle components having the same function but different characteristics, for example axle or stabilizer bushings of different stiffness without having to record unique test data at step 54 and generate unique drives using the iterative process such as described above for each different bushing.

Although illustrated in FIG. 7 in the form of a test system that is coupled to a vehicle spindle, this is but one example. Other multi-degree of freedom actuator based load applying test systems include, but are not limited to, steering gear test systems, steering knuckle test systems, control arm test systems and, in general, any application where specimen or fixture motion imparts disturbances into and/or between control channels.

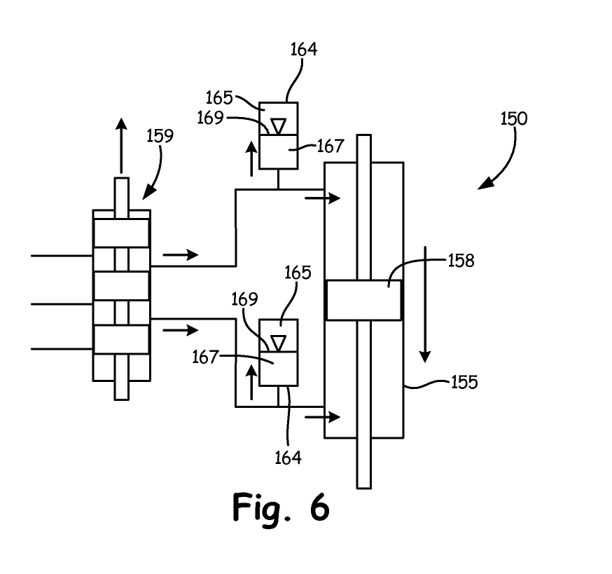

A first embodiment of a compliant actuator assembly 150 is schematically illustrated in FIG. 6. A piston 158 is slidable in a cylinder or bore 155. The piston 158 and the bore 155 operate as a double-acting hydraulic actuator, either single ended or double ended depending upon the test system design. A flow control valve 159 comprising part of servo controller 14 is fluidly coupled to the bore 155 and selectively provides hydraulic fluid to the bore 155 to displace the piston 158. An accumulator 164 is fluidly or mechanically coupled to each of the chambers or piston of the double-acting actuator. The accumulators 164 introduce a spring effect to an otherwise substantially rigid actuator. Each accumulator 164 includes a first portion 165 of compressible fluid (typically, a gas such as nitrogen, mechanical spring, or other resilient media or device,) and a second portion 167 that is filled with a liquid, which compared to the gas, is substantially incompressible. The second portion 167 of each accumulator 164 is fluidly coupled to the bore 155 or mechanically coupled to the piston 158. Commonly, a diaphragm 169 (or equivalent separating device such as a piston) is provided in each accumulator 164 to maintain separation of the spring device or media and the liquid. Using hydraulic accumulators 164, typically but not exclusively pre-charged with nitrogen gas or mechanical elements, allows tuning of the spring stiffness (i.e. the compliance) of the actuator assembly 150 to match requirements of a specific test specimen.

Other design considerations of the actuator assembly 150 can also be used to obtain desired performance. For instance, any or all of the area ratios between the accumulator 164 effective area and the area of the piston 158, the mass of the accumulator piston and/or the velocity of oil entering/exiting the accumulator 164 can be used to tune the compliance to be effective at low frequencies yet become substantially inert or at least substantially stiffer at higher frequencies that warrant less compliance and more stiffness.

U.S. Pat. No. 6,457,369 discloses other forms of actuators (linear or partially rotatory) using volumes of compressible gas to provide gas springs which can be used in the present invention, and as such is incorporated herein by reference in its entirety. It should be noted the compliant actuators described in U.S. Pat. No. 6,457,369 however are not used in the manner as taught herein. In U.S. Pat. No. 6,457,369 the compliant actuators are used to provide a high static or low frequency load that is also compliant to higher frequency input disturbances. However, some control techniques particularly with respect to hydraulic powering up or shutting down as described therein can be incorporated, if desired.

As indicated above, a compliant actuator assembly is particularly advantageous in a multiple degree of freedom (multiaxial) test system such as test system 200 illustrated in FIG. 7. Test system 200 is described in detail in U.S. Pat. No. 6,640,638, which is hereby incorporated by reference in its entirety, but nevertheless is one form of a road simulator.

Referring to FIG. 7 and the schematic representation thereof, the vehicle spindle test fixture 200 is exemplary of a system designed to apply linear force and rotational moments to a spindle of a vehicle, not shown. The vehicle spindle test fixture 200 includes a wheel adapter housing 216 that is fixed to the vehicle spindle in a conventional manner. A first loading assembly 213 includes the wheel adapter housing 216 and a pair of vertically extending loading links or struts 220. Generally, the first loading assembly 213 applies loads to the spindle, in directions along one or both of two mutually perpendicular axes 222 and 224, with actuator assemblies 223 and 225, respectively. In addition, the first loading assembly 213 can apply a moment or torque about an axis 226 that is mutually perpendicular to axes 222 and 224 using actuator assembly 227.

In the exemplary embodiment, the test fixture 200 also includes a second loading assembly 215. The second loading assembly 215 comprises a plurality, of struts 217 and at least one of actuator assemblies 219A, 219B and 229. Generally, the second loading assembly 215 can apply a force substantially along the axis 226 using actuator assembly 229 as well as a moment about axis 224 using actuator assemblies 219A and 219B, and a moment about an axis parallel to the axis 222 using actuator assemblies 219A, 219B and 229.

Each of the actuator assemblies of FIG. 7 comprise a second form of a compliant actuator assembly in that each actuator assembly includes a spring element 240 operably coupled in series with the associated actuator, which could be hydraulic or electric. The spring element can comprise a mechanical spring (e.g. coil spring) or a gas or pneumatic spring. Although illustrated in FIG. 7 as a spring element connected in series to two struts, it should be understood that that spring element may be incorporated anywhere along the load path from the actuator to the coupling to the specimen such as but not limited to being incorporated in a portion of any lever arm in the load path, or to a portion of the lever arm to provide compliant pivoting of the lever arm, or in any coupling in the load path. Commonly, the spring element would provide an axial spring effect, which can include a spring operably coupled to a lever arm to allow the pivot point of the lever arm to move with compliance as well as an axial spring element 240 as illustrated. Stated yet another way, one aspect of the present invention is to provide compliant actuator assemblies such that the stiffness of the test system is substantially less than the stiffness of the test specimen.

It should be noted that in comparison to the mechanical springs 240, the compliant actuator 150 having the compliance elements operably coupled between the double-acting actuator ends, or the fixed and single acting actuator end, may be advantageous because compliance of the actuator assembly is “inside” the control loop (signal lines 19 and 15A in FIG. 5), thereby still providing closed loop control of the resulting motions, which may reduce or eliminate uncontrolled resonant response.

A particular advantage of including a compliant actuator or assemblies in the test system is that a new drive may not be needed for testing a plurality of “similar but different” test specimens. Often, test systems of the prior art a new drive using an iterative process as that described above for each similar but different test specimen to be tested based on each corresponding test specimen's unique response data collected recorded at step 54 in FIG. 3A. However, installing each similar but different test specimen in it operating environment such as a vehicle in step 52 and recording the data is very costly in both labor and time. Likewise, generating a drive using the iterative process based on the unique recorded data is also typically very time consuming and due to the nature of the iterative process causes wear upon the test specimen and/or the test system. It has been found use of one or more compliant actuator assemblies can reduce system sensitivity, particularly to specimen induced motion, thus increasing control loop disturbance rejection capability, and allowing the same drive to be used for the plurality of similar but different test specimens.

The compliant actuator assemblies also help perform testing upon a test specimen that from time to time exhibits different characteristics during testing. The compliant load assemblies also can keep the applied forces or loads more consistent over time.

It should be noted yet another significant advantage that has been achieved with the use of the compliant actuator assemblies in the test system is that the overall number of iterations necessary to obtain the drive using an iterative process such as those discussed above has been significantly reduced when compared to a test system not having such compliant actuator assemblies. Commonly, for the reasons discussed above the iteration gain or relaxation gain factor 95 must be kept small, for example on the order of 0.3 so that overshoot does not occur and damage the test specimen. Since the relaxation gain factor is small the number of iterations required to obtain the final drive is quite large, for example, 30 iterations. It is not uncommon for each iteration to take an hour or more for test systems such as a road simulator; hence to converge upon the final drive may easily take 30 hours or more. However, use of the compliant actuator assemblies that in effect allows the test system to be substantially less stiff than the test specimen (in at least some degrees of freedom, like the horizontal channels with complete vehicle spindle coupled road simulators, or partial vehicle testing that use one or two spindle coupled road simulators, for example, to test the rear axle/suspension of a vehicle, or one corner of a vehicle suspension, or a directly coupled component test specimen such as an engine mount connected to one or more compliant actuator assemblies) allows relaxation gain factors greater than about 0.5 to be used, and in a further embodiment greater than about 0.65 to be used, and in yet a further embodiment greater than about 0.75 to be used, and in yet other further embodiments greater than about 0.8 to be used. Use of a larger relaxation gain factor drastically cuts the number of iterations required to converge upon the final drive, thereby saving considerable time and expense, where as the relaxation gain factor increases the number of iterations needed generally decreases; therefore any increase in the relaxation gain factor during can provide significant advantages since the number of iterations decreases.

At this point it should also be noted that afore-mentioned advantages are obtained for any type of model that is used during processing or calculation to arrive at a new drive signal. The type of model used is not important because it is the reduction in the number of iterations that has been achieved with the use of one or more compliant actuator assemblies in the test system. Therefore, the invention is not limited to the exemplary test system methodologies used during iteration of the drive signals, but rather can be used with, for example, both linear and non-linear models.

Yet another difference between the prior art test systems and methods and the present test system and method having compliant actuator assemblies is that one can adjust the compliance of the test system (physical test rig) to have a selected compliance or a selected stiffness relative to the test specimen, for example, by adjusting the test system to be much softer than the test specimen, such as 10% as stiff as the test specimen (in at least some degrees of freedom). This again allows a larger relaxation gain factor to be used, thereby reducing the number of iterations. Such adjustments to the stiffness or compliance of the test system may allow the relaxation gain factor to be independent of similar test specimens, for example, if the road simulator was adjusted to have 10% of the stiffness of a car in one test and 10% the stiffness of a truck in another, the same number or nearly the same number of iterations may be needed for each vehicle.

Other exemplary iterative processes and embodiments that can benefit from aspects of the present invention are described in U.S. Pat. No. 8,135,556; U.S. Published Patent Application US 2013/0304441A1; and US patent application entitled “Methods and Systems for Testing Coupled Hybrid Dynamic Systems,” filed on even date herewith, all of which are hereby incorporated by reference in its entirety.

Generally, the afore-mentioned patent and applications provide arrangements for controlling simulation of a coupled hybrid dynamic system. In one exemplary arrangement, the arrangement comprises a physical test rig configured to drive a physical structural component of the system and to generate a test rig response as a result of applying a drive signal input to the test rig. A processor is configured with a virtual model of the complementary system (herein in also “virtual model”) to the physical component (i.e. the virtual model of the complementary system and the physical component comprises the complete hybrid dynamic system). The processor receives a first part of a test rig response as an input and generates a model response of the complementary system using the first part of the received test rig response and a virtual drive as inputs. The processor is further configured to compare a different, second part of the test rig response with the corresponding response from virtual model of the complementary system to form a difference, the difference being used to form a system dynamic response model which will be used to generate the test rig drive signal.

In an embodiment, the processor is further configured to generate the test drive signal, receive the test rig response, generate a response from the virtual model of the complementary system, and compare the test rig response with the response from the virtual model of the complementary system to generate a hybrid simulation process error. The error is then reduced using an inverse of the system dynamic response model, in an iterative fashion until the difference between the response from the virtual model of the complementary system and the test rig response is below a defined threshold.

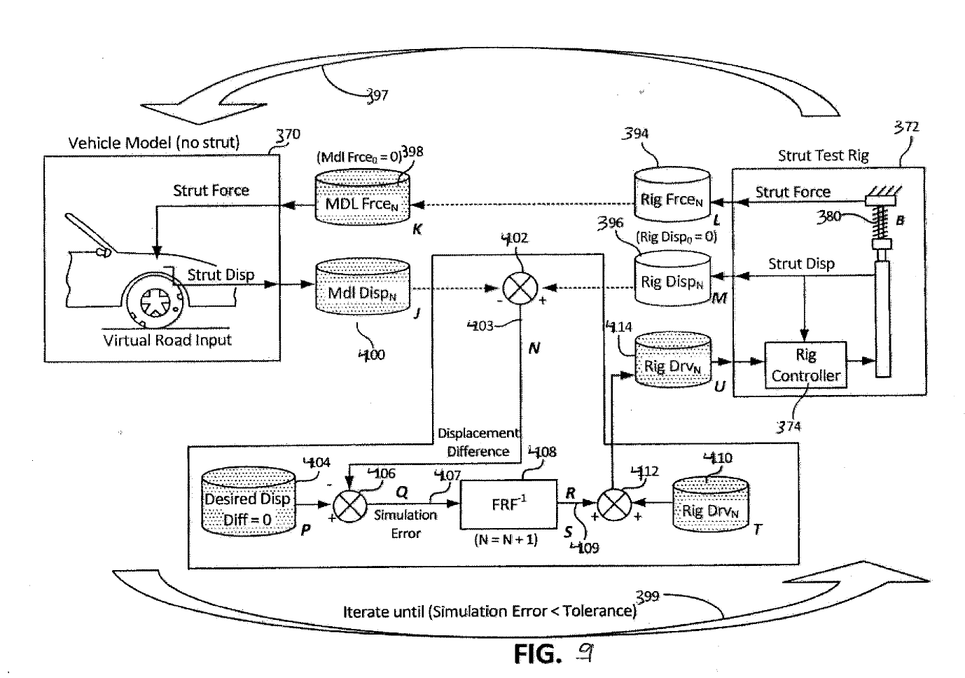

FIG. 8 depicts an exemplary arrangement for controlling the simulation for a coupled hybrid dynamic system, where it should be understood aspects of the present invention are not limited to the exemplary arrangement herein described, but rather can also be applied to any of the other arrangements in the above-identified patent and patent applications.

In the exemplary arrangement, a complementary vehicle model 370 is provided in suitable non-transitory computer readable media such as a hard disk of a computer and accessible by a processor. The model of a vehicle is exemplary only, however, as other systems may be modeled without departing from the present disclosure. Also, for purposes of explanation, the physical component is a strut employed in a vehicle suspension system. Other components may be tested, as the strut is an example only of a physical component, including but not limited to testing of a complete vehicle less actual tires and wheels as described in the above-identified patent application. A test rig 372 is also provided that accepts drive(s) and provides response(s) to any of the compliant actuator assemblies discussed above, which are a part of the test rig 372. In this example, the test rig 372 is configured to test a physical strut mounted within the test rig 372. However, the test rig 372 may be configured to test other structural components. The test rig 372 has a rig controller 374.

The arrangement forms or ascertains a system dynamic response model that can be employed to generate a drive signal used to drive the test rig 372. The system dynamic response model 376 may be a frequency response function (FRF), as one example. The system dynamic response model 376 may also be determined, or calculated, by the same processor on which the model 370 of the complementary is run. However, a system dynamic response model 376 may also be determined and calculated on a separate processor.

FIG. 8 depicts the arrangement and steps to form the system dynamic response model 376. This can be termed the system response modeling step. This system dynamic response model 376 can be employed in the iterative process of FIG. 9, described later. In FIG. 8, a random test rig drive 378 is played into the test rig 372 that has a vehicle component 380 (such as a strut) installed. The random test rig drive 378 may be a generic drive, such as a random amplitude, broadband frequency drive. Two responses are measured in the disclosed embodiment although the arrangement is not limited to two responses. One of these responses, such as a random test rig force signal 382, is to be applied to the vehicle model 370 of the complementary system. The other response, such as a random rig displacement 384, is a response to be compared to the response of the virtual model 370 of the complementary system. In the disclosed embodiment of FIG. 8, the first response 382 is the force exerted by the strut on the test rig 372, while the second response 384 is the displacement of the strut 380, which can also be provided as an input to the rig controller 374. It is to be noted that the force and displacement signals are exemplary only, as other response signals may be provided from the test rig 372.

The response from the test rig 372, such as the random rig force 382, is supplied as an input to form a random model drive 386 to the virtual vehicle model 370 of the complementary system. The virtual vehicle model 370 of the complementary system excludes the component under test, in this case the strut 380. The virtual vehicle model 370 of the complementary system responds to the random model drive input signal 386 with a random model response signal 88, in this case a displacement.

In the third step of the process, the random response 88 of the virtual model 370 of the complementary system is compared to the associated test rig random response 384. A comparison 390 is performed to form a random response difference 392 (herein by example a displacement). The relationship between the random response difference 392 and the random rig drive 378 establishes the system dynamic response model 376. The system dynamic response model 376 will be inverted and used for test rig drive prediction in the iterative simulation control process of FIG. 2.

The determination of the system dynamic response model 376 may be done in an offline process, such that high powered and high speed computing capabilities are not required. Further, since there is no need to acquire data, any component can be tested without previous knowledge of how that component is going to respond within a virtual model, or in a physical environment. The offline measurement of the system dynamic response model 376 measures the sensitivity of the difference in response 88 of the virtual model of the complementary system and rig response 384 to the rig inputs when the component 380 is in the physical system. Once the relationship between rig drive 378 and system response difference 392 has been modeled, an offline iteration process is performed, as seen in FIG. 2. This may be considered as the test drive development step.

In the iterative process of FIG. 2, which is an offline iteration, the virtual model 370 of the complementary system, which excludes the test component 380, is operated. In the exemplary embodiment, the virtual model 370 is the complementary system of a virtual vehicle and the test component that is excluded is the strut 380. The virtual vehicle is driven over a test road, to generate a response 400 of the virtual model 370 of the complementary system. As an example, the response 400 may represent a displacement of the strut 380, although since the strut 380 is not actually present, it is really the displacement of the space that would be occupied by the strut 380 that is measured by the response 400. An additional input to the virtual model 370 of the complementary system, in addition to the virtual test road input, is shown as reference numeral 398. The additional model input 398 to the vehicle model 370 of the complementary system is based on the test rig response 394 from the test rig 372. The additional model input 398, such as the force measured at the test rig 372 is applied simultaneously to the vehicle model 370 during testing. For an initial iteration (N=0), the input 398 to the virtual model 370 of the complementary system will typically be at zero.

The response 400 of the virtual model 370 of the complementary system is compared to the test rig response 396 from the test rig 372. This test rig response 396 must also be a displacement, if the response 400 of the virtual model 370 of the complementary system is a displacement. A comparison of 402 is made between the test rig response 396 and the response 400 of the virtual model 370 of the complementary system to form a response difference 403.

The response difference 403, in this case a displacement difference, is compared to a desired difference 404. Typically, the desired difference 404 will be set at zero for an iterative control process. In further embodiments, however, other desired differences may be employed without departing from the scope of the present disclosure.

The comparison 406 between the response difference 403 and the desired difference 404 produces a simulation error 407 used by the inverse (FRF-1) of the system dynamic response model 376 that was previously determined in the steps shown in FIG. 1. The inverse of the system dynamic response model 376 is depicted as reference numeral 408 in FIG. 2. A drive correction 409 is added to the previous test rig drive signal 410 at 412 to generate the next test rig drive signal 414. Typically, the simulation error 407 is reduced by a relaxation gain factor. The relaxation gain factor (or iteration gain) stabilizes the iterative process and trades off rate-of-convergence against iteration overshoot. Furthermore, the iteration gain minimizes the possibility that the test component will be overloaded during the iteration process due to non-linearities present in the physical system. As appreciated by those skilled in the art, the iteration gain can be applied to the drive correction 409, if so desired.

The next test rig drive signal 414 is applied to the test rig 372 and first and second responses are measured. The response 394 to be applied to the vehicle model 370 generates via the processor and the virtual model 370 of the complementary system, a response 400 that is compared to test rig response 396. The process is repeated iteratively (represented by arrows 397 and 399) until the resulting simulation error 407 is reduced to a desired tolerance value.

The processing of the vehicle model 370 and the determination of the final test rig drive signal 414 is capable of being performed within a single processor. However, in certain embodiments, multiple processors may be employed. Also, it should be understood that the process for determining the simulation error 407 and the determination of the test rig drive signal 414 may be performed offline.

Although the subject matter has been described in language specific to structural features and/or methodological acts, it is to be understood that the subject matter defined in the appended claims is not necessarily limited to the specific features or acts described above as has been held by the courts. Rather, the specific features and acts described above are disclosed as example forms of implementing the claims.

What is claimed is:

1. A test system comprising:
a physical test rig having a compliant actuator assembly responsive to a drive signal and a test specimen operably connected to the compliant actuator assembly;
a non-transitory computer storage device;
a processor operable with the storage device and configured to execute instructions stored on the non-transitory computer storage device that when executed
(a) apply a test drive signal to the physical test rig;
(b) obtain an actual response signal of the physical test rig and the test specimen to the test drive signal;
(c) calculate an error as a function of the actual response signal and a selected response signal;
if the error exceeds a selected threshold:
(d) obtain a new drive signal based on the error and a relaxation gain factor; and
(e) repeating steps (a) through (d) wherein the test drive signal is the new drive signal until the error reaches the selected threshold.

2. The test system of claim 1 wherein the relaxation gain factor is greater than about 0.5.

3. The test system of claim 2 wherein the relaxation gain factor is greater than about 0.65.

4. The test system of claim 3 wherein the relaxation gain factor is greater than about 0.75.

5. The test system of claim 4 wherein the relaxation gain factor is greater than about 0.8.

6. The test system of claim 1 wherein the non-transitory computer storage device stores a form of a linear or non-linear model configured for use with the physical rig and the test specimen, and wherein the new drive signal is obtained based on the error, the linear or nonlinear model and the relaxation gain factor.

7. The test system of claim 1 wherein the compliant actuator assembly comprises an actuator and a spring connecting the actuator to the test specimen.

8. The test system of claim 1 wherein the compliant actuator assembly comprises an actuator connected to the test specimen and an accumulator having a compressible fluid operably coupled to the actuator to provide compliance to the actuator.

9. The test system of claim 1 wherein compliance of the compliant actuator assembly is adjustable.

10. The test system of claim 1 and further comprising a plurality of compliant actuator assemblies responsive to a drive signal and operably connected to the test specimen.

11. The test system of claim 10 wherein the test specimen is at least a portion of a vehicle wherein at least one of the compliant actuator assembly is configured to apply a load upon said at least a portion of the vehicle in a direction corresponding substantially to forward motion of the vehicle.

12. The test system of claim 10 wherein the test specimen is at least a portion of a vehicle wherein at least one of the compliant actuator assembly is configured to apply a load upon said at least a portion of the vehicle in a direction substantially lateral to forward motion of the vehicle.

13. The test system of claim 1 wherein a compliance of the physical test rig with the compliant actuator assembly is more compliant than the test specimen.

14. The test system of claim 9 wherein the compliance of the compliant actuator assembly is configured such that the physical test rig is more compliant than the test specimen.

15. A method of controlling a test system responsive to a drive signal to produce a selected response signal, the test system comprising a physical test rig having compliance for loads applied to a test specimen, the method comprising:
(a) applying a test drive signal to the physical test rig;
(b) obtaining an actual response signal of the test system to the test drive signal;
(c) calculating with a processor an error as a function of the actual response signal and a selected response signal;
if the error has not reached a selected threshold:
(d) obtaining a new drive signal based on the error and a relaxation gain factor; and
(e) repeating steps (a) through (d) wherein the test drive signal is the new drive signal until the error is reaches the selected threshold.

16. The method of claim 15 wherein the relaxation gain factor is greater than about 0.5.

17. The method of claim 16 wherein the relaxation gain factor is greater than about 0.65.

18. The method of claim 17 wherein the relaxation gain factor is greater than about 0.75.

19. The method of claim 18 wherein the relaxation gain factor is greater than about 0.8.

20. The method of claim 15 and further comprising adjusting the compliance of the physical test rig.

21. The method of claim 15 and further comprising after step (e):
(f) applying the new drive signal that corresponds to the error reaching the selected threshold to the test system to conduct testing on the test specimen;
(g) replacing the test specimen in the test system with a new test specimen being similar but different than the test specimen; and
(h) applying the new drive signal that corresponds to the error reaching the selected threshold to the new test system to conduct testing on the newtest specimen.
